(19) United States
(12) Patent Application Publication
(10) Pub. No.: US 2007/0080507 A1
(43) Pub. Date: Apr. 12, 2007

(54) Handheld power tool, in particular a drill or screwdriver

(76) Inventors: Bruno Aeberhard, Studen (CH); Raymond Brantschen, Niklaus (CH); Urs Roth, Flumenthal (CH); Huynh Cuong, Zuchwil (CH); Beat Salzeber, Visp (CH)

Correspondence Address: Striker Striker & Stenby, 103 East Neck Road, Huntington, NY, 11743, US

(21) Appl. No.: 10/579,480

(22) PCT Filed: Aug. 30, 2005
(86) PCT No.: PCT/EP05/54254

§ 371 Date: May 16, 2006

(30) Foreign Application Priority Data
Nov. 8, 2004 (DE) 10 2004 053 783.6

(51) Int. Cl. B23B 31/02

(52) U.S. Cl. 279/143

(57) ABSTRACT

An electric hand-held power tool, in particular a power drill or screwdriver, is disclosed, which has a chuck (14) for a tool, a drive spindle (13) which drives the chuck (14) and protrudes with a spindle head (131) into a recess (15) embodied in the chuck (14), and connecting means, operative between the spindle head (131) and the recess (15), for connecting the drive spindle (13) and the chuck (14) in a manner fixed against relative rotation. For achieving a connection between the chuck (14) and the drive spindle (13) that is very simple from a production standpoint and hence economical and that even in drive spindles with a reversible direction of rotation assures reliable, non-rescindable torque transmission, the connecting means have axially extending cutting edges (26), embodied on the spindle head (131), that cut into the wall of the recess (15) when the chuck (14) is being slipped onto the spindle head (131) (FIG. 2).

### PRIOR ART

The invention is based on a hand-held power tool, in particular a power drill or a screwdriver, as generically defined by the preamble to claim 1.

In a known electric hand-held power tool, the reduced-diameter end portion or spindle head of the drive spindle is provided with a male thread, and the recess in the chuck is provided with a female thread that can be screwed onto the male thread. A central threaded bore is made in the face end of the spindle head, and in the chuck there is a through bore, which is coaxial with the threaded bore and in which a bracing shoulder is embodied that protrudes radially into the through bore. For connecting the drive spindle and the chuck in a manner fixed against relative rotation, the chuck is screwed onto the male thread of the spindle head until the screw connection blocks. A cap screw is then screwed into the central threaded bore until its screw head strikes the bracing shoulder, so that the screwed-on spindle head is fixed against reverse rotation. The thread connecting the spindle head and the chuck is embodied such that the screwing-on direction of the chuck is contrary to the direction of rotation of the drive spindle.

### ADVANTAGES OF THE INVENTION

The hand-held power tool of the invention, having the characteristics of claim 1, has the advantage that a connection between the chuck and the drive spindle that is very simple from a production standpoint and hence economical is attained that even in drive spindles with a reversible direction of rotation, such as is required for so-called power screws, assures reliable, non-rescindable torque transmission.

By the provisions recited in the other claims, advantageous refinements of and improvements to the hand-held power tool recited in claim 1 are possible.

In an advantageous feature of the invention, a coaxial threaded bore is made in the spindle head, from its free face end inward, into which a cap screw, which can be introduced into the chuck and is axially braced in the chuck with its screw head, can be screwed with its screw shank. Screwing the cap screw in pulls the chuck, with its recess, axially onto the spindle head, whereupon the axial cutting edges embodied on the spindle head increasingly dig axially into the wall of the recess and there establish a form-locking connection between the spindle head and the chuck.

Since in a preferred feature of the invention the spindle head is hardened, secure cutting into the softer material of the chuck is assured.

In an advantageous feature of the invention, the spindle head and the recess are embodied cylindrically, and the axial cutting edges are formed by a notched toothing encircling the spindle head. Alternatively, only the recess may be embodied cylindrically, while the spindle head, at least in one portion, may be embodied as a polygonal prism, such as a regular hexagonal prism, with the corner edges of the polygonal prism forming the cutting edges.

In an advantageous feature of the invention, a female-threaded portion is located in the chuck, in the introduction region of the cap screw, and its inside diameter is greater than the outside diameter of the screw shank of the cap screw. With the aid of this female thread, by means of screwing a disassembly screw into it that is braced on the spindle head with the free end of the screw shank of the disassembly screw, the drive spindle can be pushed out of the recess in the chuck and the chuck can thus be disconnected from the drive spindle again. The bracing of the disassembly screw can be done for instance on the face end of the spindle head, on the bottom of a blind bore thread embodied in the spindle head for screwing in an assembly and securing screw, or on a chamfer surrounding the bore opening of the blind bore thread.

### DRAWINGS

The invention is described in further detail below in terms of an exemplary embodiment shown in the drawings. Shown are:

FIG. 1, a perspective view of an electric hand-held power tool, with its chuck removed from the drive spindle;

FIG. 2, a detail, partly in section, schematically showing the drive spindle and the chuck in the installed position;

FIG. 3, a section taken along the line III-III in FIG. 2;

FIG. 4, a view identical to FIG. 3, with a modified drive spindle;

FIG. 5, a detail in longitudinal section of the drive spindle;

FIG. 6, a side view of an assembly and securing screw, shown enlarged, that can be screwed into the drive spindle.

### DESCRIPTION OF THE EXEMPLARY EMBODIMENT

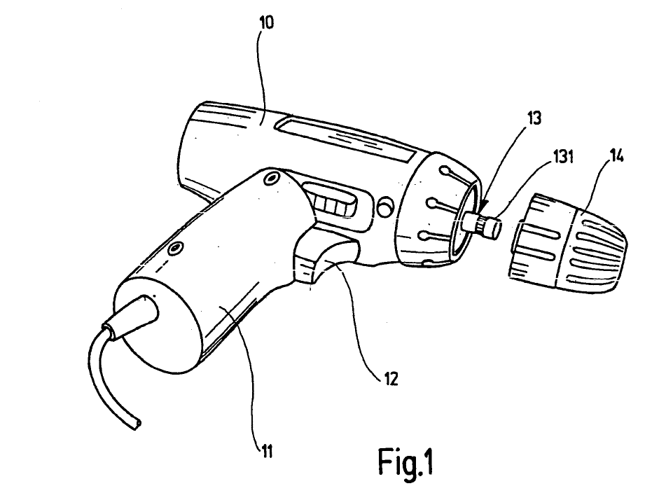

The electric hand-held power tool shown in perspective in FIG. 1 may be used as a power drill or a screwdriver. It has a housing 10 with an integrally formed handle 11, on which there is an on/off switch 12 for an electric motor that is received in the housing 10. In a known manner, not further shown, the electric motor, via a gear, drives a drive spindle 13, which is received rotatably in the housing 10 and protrudes from the housing 10 with a spindle head 131. A chuck 14 for chucking a drill bit or screwdriver bit is received on the spindle head 131 in a manner fixed against relative rotation.

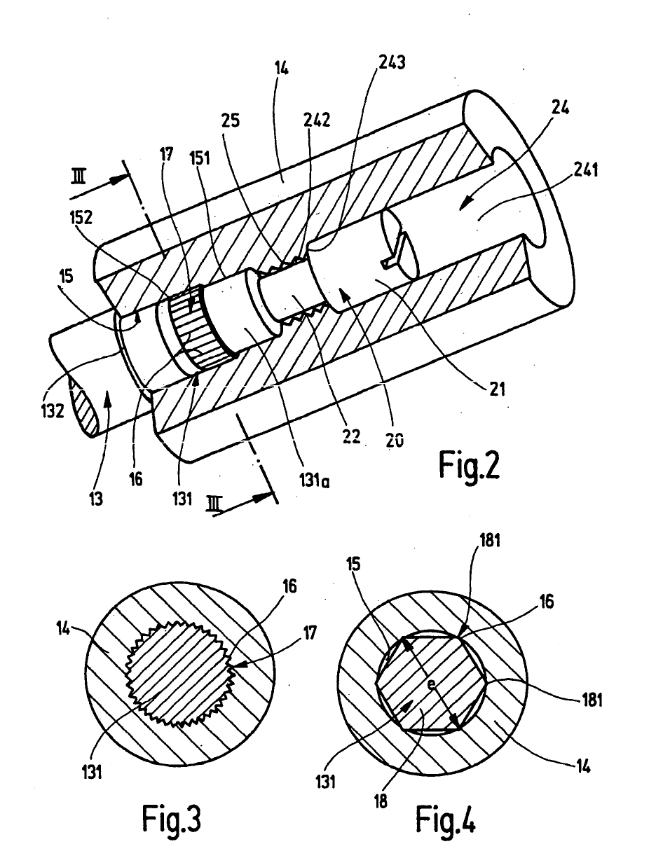

The connection, fixed against relative rotation, between the drive spindle 13 and the chuck 14 is sketched schematically and enlarged in FIG. 2. The chuck 14 has a coaxial recess 15, which comes to an end in the open on the face end of the chuck 14 facing toward the housing 10. The recess 15 is smooth-walled and cylindrically stepped, and an inner portion 151 has a smaller inside diameter than an adjacent outer portion 152. Axially extending cutting edges 16 are embodied on the spindle head 131, and their outside diameter is greater than the inside diameter of the outer portion 152 of the recess 15, so that as the chuck 14 is being slipped or press-fitted onto the spindle head 131, these cutting edges cut into the wall of the outer portion 152 of the recess 15. In the process, the chuck 14 is thrust onto the spindle head 131 far enough that the face end of the spindle head 131 strikes the bottom of the recess 15. The spindle head 131 with the cutting edges 16 is hardened or is of a harder material than the chuck 14, so that the cutting edges 16 dig well into the softer material of the chuck.

In the exemplary embodiment of FIGS. 2 and 3, the spindle head 131 is embodied cylindrically, and on a cylindrical portion that is set back from the free end of the spindle head 131, it has an encircling notched toothing 17, whose teeth form the cutting edges 16. Preceding the cylindrical portion that has the cutting edges 16 is a cylindrical guide portion 131a, whose outside diameter is adapted to the inside diameter of the inner portion 151 of the recess 15, so that as the spindle head 14 is being pushed onto the spindle head 131, the chuck 14 first slides without play on the guide portion 131a, before the cutting edges 16 dig into the material of the chuck. As a result, the concentricity of the chuck 14, fixed on the spindle 13, is assured. Alternatively, at least in the region of the cylindrical portion that has a cutting edges 16, the spindle head 131 can also be embodied as a polygonal prism, whose corner edges form the cutting edges 16. To that end, the diagonal size of the corners of the polygonal prism is made larger than the inside diameter of the outer portion 152 of the recess 15. In the sectional view in FIG. 4, the embodiment of the spindle head 131 as a regular hexagonal prism 18 is shown as an exemplary embodiment of a polygonal prism. The diagonal corner size e of the hexagonal prism 18 is greater than the inside diameter of the outer portion 152 of the recess 15, so that the corner edges 181 of the hexagonal prism 18 that form the cutting edges 16 cut into the wall of the recess 15. The guide portion 131a on the end of the spindle head 131 remains as is.

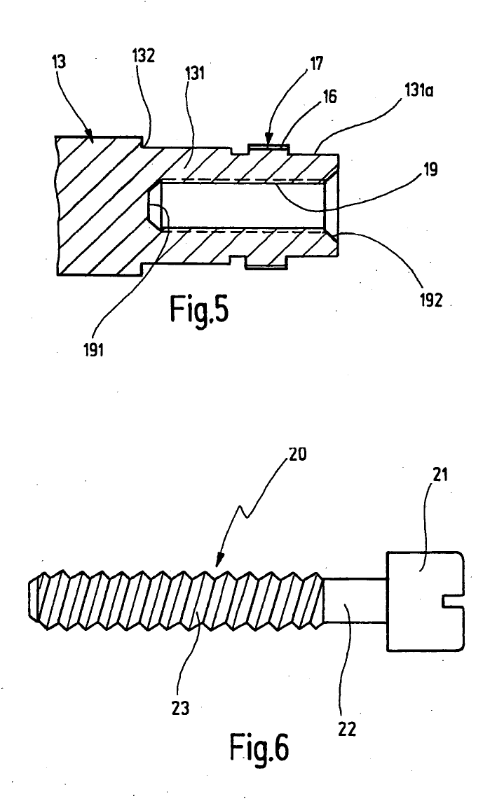

As the sectional view in FIG. 5 shows, a screw head g 19 is cut into the spindle head 131, from its face end facing toward the chuck 14. An assembly and securing screw 20, shown in FIG. 6, has a screw head 21 and a screw shank 22 of reduced diameter compared to the screw head, and this screw shank has a male thread 23. The male thread 22 is adapted to the female thread of the threaded bore 19 so that the assembly and securing screw 20 can be screwed into the threaded bore 19. In the chuck 14, there is a stepped bore 24, which is located coaxially with the recess 15 and which ends with its larger-diameter bore portion 241 on the face end of the chuck 14 facing away from the drive spindle 13, and whose smaller-diameter bore portion 242 comes to an end in the recess 15. The diameter of the larger-diameter bore portion 241 is made greater than the outside diameter of the screw head 21 of the assembly and securing screw 20, and the diameter of the smaller-diameter bore portion 242 is made greater than the outside diameter of the screw shank 22 and smaller than the outside diameter of the screw head 21. The annular shoulder 243 formed at the transition from the larger-diameter bore portion 241 to the smaller-diameter 242 thus forms an axial bracing face for the screw head 21 of the assembly and securing screw 20.

For joining the chuck 14 to the spindle head 131 of the drive spindle 13, the assembly and securing screw 20 is introduced into the stepped bore 24 in the chuck 14 and is screwed by its screw shank 22 into the threaded bore 19 in the spindle head 131 that is mounted coaxially on the chuck 14. By increasingly screwing the screw shank 22 in the threaded bore 19, with the screw head 21 braced on the annular shoulder 243, the spindle head 131 is increasingly drawn inward axially into the recess 15; first, the guide portion 131a plunges into the inner, smaller-diameter portion 151 of the recess 15 and guides the chuck 14 during the relative displacement, before the cutting edges 16 on the spindle head 131, or in other words the notched toothing 17 or the corner edges 191 of the hexagonal prism 18, increasingly cut into the wall of the outer portion 152 of the recess 15. At the end of the assembly operation, the face end of the spindle head 131 rests on the bottom of the recess 15 and is secured against axial displacement in the recess 15 by the assembly and securing screw 20 braced on the annular shoulder 243. Alternatively, the spindle 13 may also be provided with a collar or annular shoulder 132 (FIGS. 2 and 5), which is formed on the spindle 13 on the side of the cylindrical portion that has the cutting edges 16 and that faces away from the guide portion 131a. This collar or annular shoulder 132 then serves as a stop, on which the chuck 14 rests at the end of the assembly operation, and is axially fixed in the spindle head by means of the assembly and securing screw 22.

For disconnecting the spindle head 131 and the chuck 14, a threaded portion 25 is embodied in the smaller-diameter bore portion 242, and a disassembly screw, not separately shown here, is furnished, which may be a normal cap screw or a screw pin with a male thread that can be screwed into the threaded portion 25, and which is capable of bracing itself, with its leading end face in terms of the screwing-in direction, on the end face of the spindle head 131 that is resting on the bottom of the recess 15. By screwing the disassembly screw in the threaded portion 25, the spindle head 181 is pushed axially out of the chuck 14. Alternatively, in the disassembly operation, by suitable modification of the disassembly screw, the latter can also be braced on the bottom 191 (FIG. 5) of the threaded bore 19, embodied as a blind bore, in the spindle head 131 or on a chamfer 192 (FIG. 5) coaxially surrounding the bore opening of the threaded bore 19.

The invention is not limited to the exemplary embodiment described. For instance, the recess 15 may have a cross section that is other than cylindrical. The embodiment of the spindle head 131 with the cutting edges 16 is adapted accordingly, so that it is assured that when the spindle head 131 is drawn axially into the chuck 14, its cutting edges 16 will dig into the wall of the recess 15.

Alternatively, the assembly of the chuck 14 can also be done by press-fitting the chuck 14 onto the spindle head 131. In that case, the only function of the assembly and securing screw 22 is then the securing function during operation of the hand-held power tool.

1. A hand-held power tool, in particular a power drill or screwdriver, having a chuck (14) for a tool, having a drive spindle (13) which drives the chuck (14) and protrudes with a spindle head (131) into a recess (15) embodied in the chuck (14), and having connecting means, operative between the spindle head (131) and the recess (15), for connecting the drive spindle (13) and the chuck (14) in a manner fixed against relative rotation, characterized in that the connecting means have axially extending cutting edges (16), embodied on the spindle head (131), that cut into the wall of the recess (15) when the chuck (14) is being slipped onto the spindle head (131).

2. The hand-held power tool as defined by claim 1, characterized in that the recess (15) in the chuck (14) is embodied with a stepped diameter and has an inner portion (151) with an inside diameter that is smaller than that of the adjacent outer portion (152); and that the cutting edges (16) are located on a portion of the spindle head that is set back from the free end of the spindle head (131), and on the free end of the spindle head (131), a guide portion (131a) preceding said portion of the spindle head is embodied, whose outside diameter, for guiding the chuck (14), is adapted to the inside diameter of the inner portion (151) of the recess (15).

3. The hand-held power tool as defined by claim 2, characterized in that the inside diameter of the outer portion 162 of the recess (15) in the chuck (15), so that the cutting edges (16) on the spindle head (131) can cut into the chuck (14), is smaller than the outside diameter of the cutting edges (16).

4. The hand-held power tool as defined by claim 1, characterized in that the spindle head (131) with the cutting edges (16) is hardened, or is of harder material than the chuck (14).

5. The hand-held power tool as defined by claim 1, characterized in that the recess (15) and spindle head (131) are embodied cylindrically, and the cutting edges (16) are formed by a notched toothing (17) encircling the spindle head (131).

6. The hand-held power tool as defined by claim 2, characterized in that the recess (15) is embodied cylindrically and the spindle head (131), at least in the region of the portion of the spindle head that has the cutting edges (16), is embodied as a polygonal prism; and that the cutting edges (16) are formed by the corner edges (181) of the polygonal prism.

7. The hand-held power tool as defined by claim 6, characterized in that the polygonal prism is a regular hexagonal prism (16), whose diagonal corner measurement (e) is greater than the inside diameter of the outer portion (152) of the recess (15).

8. The hand-held power tool as defined by claim 1, characterized in that in the spindle head (131), there is a coaxial threaded bore (19), terminating in the free face end of the spindle head, into which bore an assembly and securing screw (20) axially braced in the chuck (14) can be screwed.

9. The hand-held power tool as defined by claim 8, characterized in that the assembly and securing screw (20) has a screw head (21) and a screw shank (22) that has a male thread (23); and that a female-threaded portion (25) is located in the chuck (14), in the region where the assembly and securing screw (20) is introduced, and its inside diameter is greater than the outside diameter of the screw shank (22) of the assembly and securing screw (20).

10. The hand-held power tool as defined by claim 9, characterized in that in the chuck (14), a stepped bore (24), has having one smaller-diameter bore portion (242), terminating coaxially in the recess (15), whose bore diameter is greater than the outside diameter of the screw shank (22), and one larger-diameter bore portion (241), whose bore diameter is greater than the outside diameter of the screw head (21) of the assembly and securing screw (20).

11. The hand-held power tool as defined by claim 10, characterized in that the female-threaded portion (25) is located in the smaller-diameter bore portion (242) of the stepped bore (24).

12. The hand-held power tool as defined by claim 9, characterized in that a disassembly screw is provided, which has a dd with a male thread that can be screwed into the female-threaded portion (25) and which is capable of being braced on the spindle head (131), for instance on the face end of the spindle head (131) facing toward the stepped bore (24), or on the bottom (191) of the threaded bore (19), embodied as a blind bore, in the spindle head (131), or on a chamfer (191) surrounding the bore opening of the threaded bore (19).
